(19) United States
(12) Patent Application Publication
(10) Pub. No.: US 2010/0114875 A1
(43) Pub. Date: May 6, 2010

(54) SYSTEM AND METHOD FOR GENERIC MULTIPLE ATTRIBUTE CONCURRENT SEARCHING

(75) Inventor: Gil Fuchs, Woodside, CA (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/263,294

(22) Filed: Oct. 31, 2008

(51) Int. Cl. G06F 7/10; G06F 17/30

(52) U.S. Cl. 707/722; 707/E17.014

(57) ABSTRACT

A system and method for multiple attribute concurrent searching using a visual paradigm. The system allows the user to locate and display a first data item in the database, graphically select attributes, values or other criteria associated with that data item, and instruct the system to use these criteria as a constraint in successive ordering and access of other data items either in a previously retrieved set of data items, or as a new search in the database itself. When the user clicks on a “next” icon, “next” button, or a similar search-initiation feature, the system uses the constraints previously selected to locate, organize, or place into a logical order the next data item matching those constraints. In accordance with an embodiment for use with digital maps and digital map databases, the system provides a graphical window screen by which a user can select attributes associated with a particular map item, and use these attributes and constraints in subsequent ordering and searching. When the user clicks or selects a particular map item attribute, that attribute can be added as one of the search constraints. Clicking the “next” button allows the system to perform the ordering or search using the previously selected constraints. Successive clicks of the next feature allow a succession of map items matching the constraint to be quickly selected and viewed.

### CROSS REFERENCE TO RELATED APPLICATIONS

This application is related to U.S. Pat. No. 7,103,854, titled “SYSTEM AND METHOD FOR ASSOCIATING TEXT AND GRAPHICAL VIEWS OF MAP INFORMATION”, issued on Sep. 5, 2006, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is generally related to means of searching within data, and particularly to a system and method for multiple attribute concurrent ordering and searching of data items, with particular application to digital map technology.

### BACKGROUND

The increasing use of computer systems necessarily results in ever increasing amounts of data. Every computer or software application uses large amounts of data, and typically stores this data in a database format or some other form or repository for easy access. Typical software applications include e-commerce applications, on-line catalogs and on-line consumer shops, national databases or information systems including on-line directories, scientific and engineering applications, and geographic data systems including those that use digital map technology. In many instances, the application may itself use the data. However, in a large amount of applications, a user may wish to directly access, use, or browse the data. This may be, for example, an end user, who wishes to browse the data for their purposes. It is also useful for those who create the database systems, such as software designers, programmers, developers and debuggers, data content creators including digital map content creators, and other users who may wish to access the data and the information therein in a manner that allows them to verify its accuracy.

To date, many methods exist for allowing a user to access an on-line, electronic, or other database or data system such that they can view the data items therein. Many of these approaches allow the user to view a simple list of data, or to perform a search to locate, view or update specific data items matching a search criteria. While the former approach, i.e., providing a simple text output of the data within the database, provides the user with an easy means to visually browse the data; this approach lacks the finesse of providing searching abilities to the end user. As such, the former approach is useful only in handling small databases or data collections, that have relatively few data items. As the number of data items becomes increasingly large, the simple viewing approach is no longer viable, since it takes too long for the end user to locate the desired data item.

The latter approach, i.e., the use of a search interface, provides benefits in that it allows a user to quickly locate data items for which the user has a specific requirement in mind. However, this approach is disadvantageous in that it typically requires the user to commit to a predefined search methodology in order to locate the desired data items. This approach also lacks the visual usability of the former approach, and rarely allows the user to visually browse a set of data items in order to find desired entries. In short, this latter approach does not lend itself to a serendipitous examination of data items within a database.

In some areas of industry, for example the digital map industry, the merging of graphical and textual data is such that neither of the above approaches are successful in allowing an end user or a software or database developer to quickly locate desired data items within the database for such purposes as updating or verification. Nor do any of the previous approaches allow the software developer or user to serendipitously browse through the database for items matching their criteria.

### SUMMARY

Disclosed herein is a system and method for multiple attribute concurrent searching using a visual paradigm. In accordance with an embodiment, in a database, digital map, or other data storage, semantic links or relationships can be used to connect different data items that have common or related attributes. The semantic links allow a set of the data items to be searched, retrieved and grouped according to relationships between those data items. The system allows the user to locate and display a first data item in the database, graphically select attributes, values or other criteria associated with that data item, and instruct the system to use these criteria as a constraint in successive ordering and access of other data items either in the previously retrieved set of data items, or as a new search in the database itself. When the user clicks on a “next” icon, “next” button, or a similar search-initiation feature, the system uses the constraints previously selected to locate, organize, or place into a logical order the next data item matching those constraints. (A “previous” icon, “previous” button, or similar feature works the same, but in the reverse direction). In accordance with an embodiment for use with digital maps and digital map databases, the system provides a graphical window screen by which a user can select attributes associated with a particular map item, and use these attributes and constraints in subsequent ordering and searching. When the user clicks or selects a particular map item attribute, that attribute can be added as one of the search constraints. Clicking the “next” button allows the system to perform the ordering or search using the previously selected constraints. Successive clicks of the next feature allow a succession of map items matching the constraint to be quickly selected and viewed. At any time, the search constraints can be changed by the user to remove, add, or edit constraints, so that the “next” button performs a different ordering or search. Since, in accordance with an embodiment, the primary search interface is graphical, and criteria are selected using a point-and-click interface, the ordering and search technique is quick, intuitive, and is powerful in allowing the user to traverse to the desired data items. Such an approach lends itself well to large database systems, containing millions of data items, and particularly to applications in which the user, who may be an end user or a software developer, data content creator including digital map content creators, or any other user who may wish to browse or otherwise search through those data items in a serendipitous manner.

### BRIEF DESCRIPTION OF THE FIGURES

FIG. 1 illustrates a typical digital map system that can be used with an embodiment of the invention.

FIG. 2 illustrates a successive selection interface that may be used with a digital map system in accordance with an embodiment.

FIG. 3 illustrates an overview of the traversal process provided by the selection interface.

FIG. 4 illustrates graphically how the traversal process can be used with a visual text record display interface to allow a user to graphically change the search criteria and successively perform searches to locate desired data items.

FIG. 5 illustrates a process in accordance with an embodiment of the invention that illustrates how the system receives information from the user and then uses this information to perform a concurrent search in the graphical environment, allowing the user to dynamically modify their search criteria to further specify certain attributes.

FIG. 6 graphically illustrates how the embodiment of the invention described in FIG. 5 above can be used to quickly locate street items that match the users criteria, selected from the map example shown in FIG. 1.

### DETAILED DESCRIPTION

As described above, traditional approaches to database searching have difficulties in allowing a user, such as a software developer or a content creator, to quickly locate desired data items within the database for such purposes as updating or verification. Traditional approaches likewise do not allow the user to serendipitously browse through the database for data items matching a set of criteria. Accordingly, it is desired to provide a new approach that successfully uses features from simple text listing and visual presentation of data items, combined with a search interface that allows a user to quickly locate data items within the database matching their search criteria. In accordance with an embodiment a system and method is provided for multiple attribute concurrent searching using a visual paradigm. In accordance with an embodiment, in a database, digital map, or other data storage, semantic links or relationships can be used to connect different data items that have common or related attributes. The semantic links allow a set of the data items to be searched, retrieved and grouped according to relationships between those data items. The system allows the user to locate and display a first data item in the database, graphically select attributes, values or other criteria associated with that data item, and instruct the system to use these criteria as a constraint in successive ordering and access of other data items either in the previously retrieved set of data items, or as a new search in the database itself. When the user clicks on a “next” icon, “next” button, or a similar search-initiation feature, the system uses the constraints previously selected to locate, organize, or place into a logical order the next data item matching those constraints. (A “previous” icon, “previous” button, or similar feature works the same, but in the reverse direction). In accordance with an embodiment for use with digital maps and digital map databases, the system provides a graphical window screen by which a user can select attributes associated with a particular map item, and use these attributes and constraints in subsequent ordering and searching. When the user clicks or selects a particular map item attribute, that attribute can be added as one of the search constraints. Clicking the “next” button allows the system to perform the ordering or search using the previously selected constraints. Successive clicks of the next feature allow a succession of map items matching the constraint to be quickly selected and viewed. At any time, the search constraints can be changed by the user to remove, add, or edit constraints, so that the “next” button performs a different ordering or search. Since, in accordance with an embodiment, the primary search interface is graphical, and criteria are selected using a point-and-click interface, the ordering and search technique is quick, intuitive, and is powerful in allowing the user to traverse to the desired data items. Such an approach lends itself well to large database systems, containing millions of data items, and particularly to applications in which the user, who may be an end user or a software developer, data content creator including digital map content creators, or any other user who may wish to browse or otherwise search through those data items in a serendipitous manner.

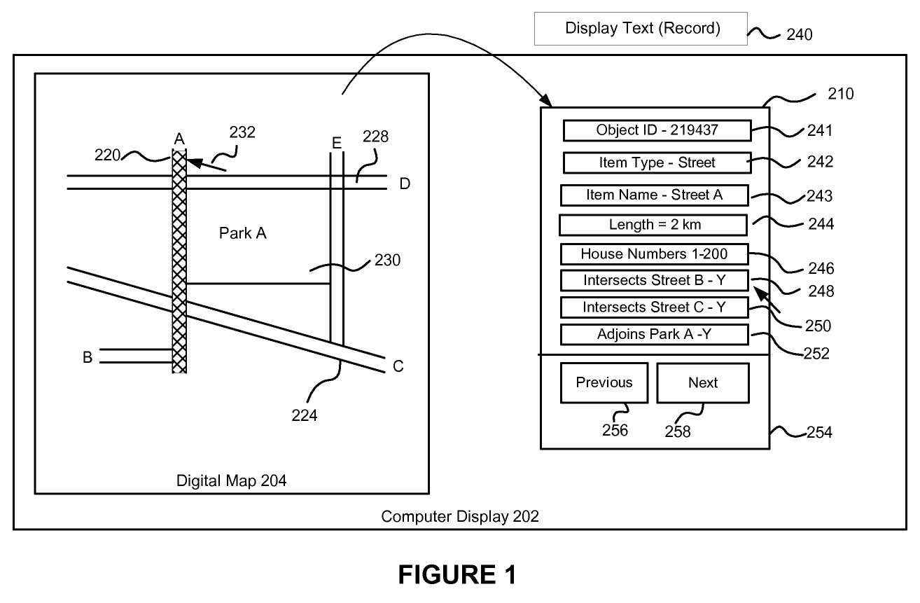

FIG. 1 illustrates a typical digital map system that can be used with an embodiment of the invention. Although the invention is described herein use with a digital map system, it will be evident to one of ordinary skill in the art that the techniques and algorithms described herein may equally be used with any type of database system and particularly with any type of database, data repository, or data access system that provides the user with a user interface or other means to view data items. An embodiment of the invention is particularly useful in digital map technology wherein the data is often represented as a digital map or a set of digital map elements on the user's screen. In such instances, the ability to graphically view, search for, and select data items is particularly useful. Other types of graphical systems and uses may be envisaged within the spirit and scope of the invention, including engineering, scientific, and medical applications.

As shown in FIG. 1, in the embodiment shown therein, the user's computer screen includes a display window 202, in which a digital map 204 is displayed, together with a text window 210, which is used to display attributes associated with digital map items. Semantic links are described in further detail in U.S. Pat. No. 7,103,854, titled “SYSTEM AND METHOD FOR ASSOCIATING TEXT AND GRAPHICAL VIEWS OF MAP INFORMATION”, issued on Sep. 5, 2006, and incorporated herein by reference. As shown in FIG. 1, when the user wishes to view or edit a particular map item, or more correctly the data item associated with that map item, the user can select the map item from within the digital map 204. As further shown in FIG. 1, the digital map includes a number of streets including street A 220, street B 222, street C 224, street D 228, and street E; and a park A 230. Selecting one of the map elements, in this example the street A indicated by the arrow 232, causes the system to display or update 240 the text record 210 associated with that selected map item. In the example shown in FIG. 1, street A is selected, which causes the text record to be displayed or updated to reflect the attributes or data associated with street A. In this example, these attributes can include a unique identifier for the map or data item 241, the item's type (such as “street”) and subtype (such as “highway” or “minor road”), the street name 243, the length 244, the house numbers on the street 246, and the street intersections, including in this instance an intersection with street B 248, and an intersection with street C 250. Other attributes such as, for example, that street A adjoins park A 252 may also be shown in the text record. In accordance with an embodiment the text record also includes navigation commands, including a “previous” button 256, a “next” button 258, and a “back” button 259, which can be used by the user to navigate between successive data items of similar type. For example, clicking on the “next” button 258 allows the user to move from the first street selected to a second street, and then to a third street. In accordance with an embodiment, the system, upon detecting a “next” request, determines which attribute the data is currently sorted by, determines any semantic links to that attribute, retrieves the next numerically or alphabetically higher data item from the database with regard to that attribute, and then displays the retrieved data item and/or its data attributes. In accordance with other embodiments, the system can order and search according to data types and subtypes (for example, a data type can be a street, and a subtype can be a minor road, major road, or highway).

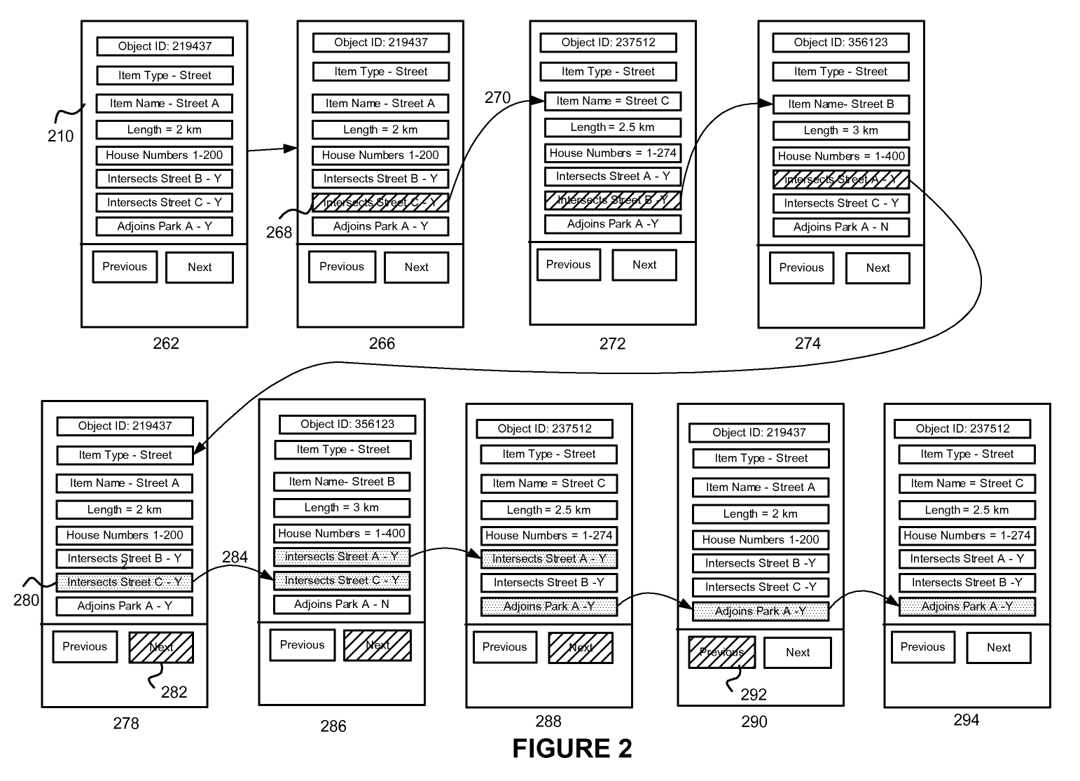

FIG. 2 illustrates a successive selection interface that may be used with a digital map system in accordance with an embodiment. As shown in FIG. 2, an initial data item 262, in this instance street B, is displayed in the text record 210. In accordance with an embodiment the initial data item can be selected in a number of ways including a search technique that retrieves a set of data items from a database, or in the case of a digital map by the system allowing the user to graphically select a map item from the map display. The user may select any of the attributes associated with this initial data item, for example the street name. At this point, depending on how the user chooses to traverse through the set of data items, the system will respond differently. If the user chooses to click on a data item having a semantic link, then the system follows that semantic link, and displays the successively linked data items. In the example shown 266 in FIG. 2, clicking on the “Intersects Street C” attribute 268 traverses the semantic link 270 and displays the record for street C 272. Clicking then on the “Intersects Street B” attribute displays the record for street B 274. However, in accordance with an embodiment, the user can instead choose to set constraints on one or more attribute/value pairs, and order the data items according to the attributes and values of the data items, either in the previously searched set of data items, or as a new search in the database itself. Starting again from the data item for street A 278, if a textual attribute has been selected then the “next” search can be performed using a lexicographic search; whereas if a numeric attribute has been selected then the “next” search can be performed using a numeric search. When the user sets constraints on one or more attributes and selects the “next” button the system retrieves and displays the data item that is most closely related to the current data data item, e.g. the data item that has the next successively higher, lower, or same attribute value. In the example shown in FIG. 2, when the user specifies a constraint of attribute:intersects street C; and value:yes 280; and selects the “next” button 282, the system retrieves 284 and displays the data item that is most closely related to street A in accordance with this constraint, in this instance street B 286. The attributes associated with street B data item are then displayed within the text window. Similarly, when the user changes the constraint to attribute:intersects street A; and value:yes; and selects the “next” button the system retrieves and displays the data item that is most closely related to street B in accordance with this constraint, in this instance street C 288. In accordance with other embodiments, alternative attributes can be used, for example that the data item also adjoins park A 290, or the use of unique identifiers for each data item object. Since in some instances the unique identifier is assigned randomly or chronologically as data items are added to the database it may or may not have practical usage to the user as a search attribute. As described above, a “previous” icon, “previous” button, or similar feature 292 works in the same manner as “next”, but in the reverse direction, so that a user can traverse in reverse 294 as desired. As also described above, in accordance with an embodiment, when the user chooses to set constraints on one or more attribute/value pairs, and select “next” or “previous”, the data items that are ordered according to their attributes and values are either those data items in a previously searched set of data items, or as a new search in the database itself. In accordance with some embodiments it is more computationally efficient to store the results of an initial user search of a database as a cached set of data items, and allow subsequent ordering and traversal of this cached set of data items, rather than accessing the database at each “next” or “previous” request. The decision to sort a cache or set of data items, rather than access the database each time, is implementation-specific and dependent on the needs of a particular application.

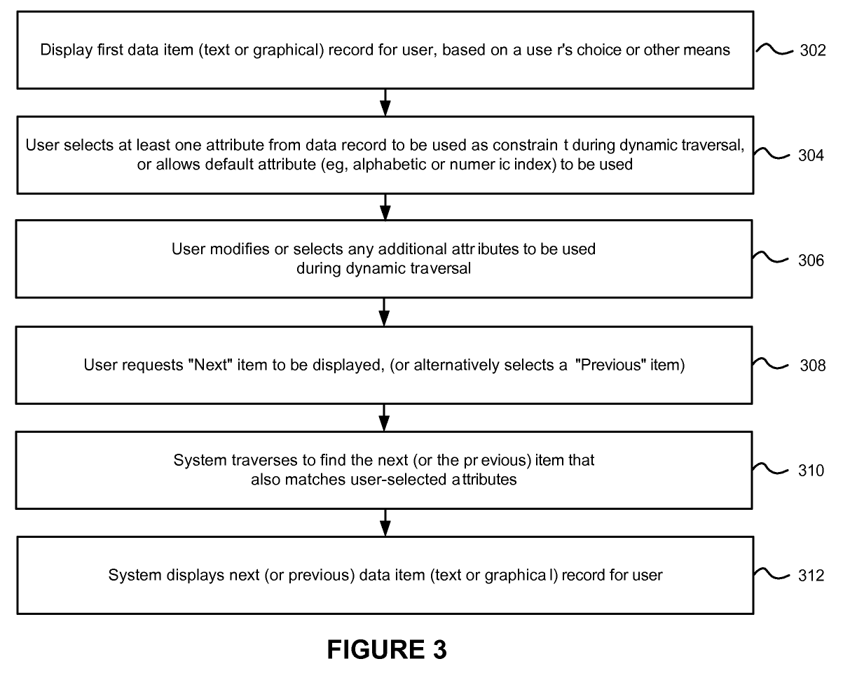

Although the interface described above allows the user to quickly select and traverse successive data items of a common data type (such as street names), it does not allow the user to further narrow down the ordering or search criteria to find a desired data item or set of data items. To address this, an embodiment of the invention provides an alternative approach, in which the user can traverse the database by further constraining their search criteria. FIG. 3 illustrates an overview of the process associated with this embodiment of the invention. As shown in FIG. 3, in step 302, the system initially displays a first data record to the user. In step 304, the user selects at least one attribute from the data record to be used as an initial ordering or search constraint during the dynamic traversal process. In some instances the user can allow a default attribute, for example an alphabetic or numeric index, to be used as by default as the initial constraint. In step 306, the user modifies, removes, or selects any additional attributes to be subsequently used during the dynamic traversal process. This modifies the search constraint. In step 308, the user then signals to the system, generally by means of clicking a “next” button, “previous” button, or some similar means, to order or retrieve the next, (previous), or successive matching data item either from the previously retrieved set of data items, or from the database. In step 310, the system then traverses within the set of data items to find the next data item that matches the user's selected attributes. In step 312 the system displays the next data record for the user. The process may then continue as described above to allow the user to successively modify or constrain the search criteria, select the “next” button to dynamically change their search pattern, and quickly traverse the set of data items or database to find desired data items.

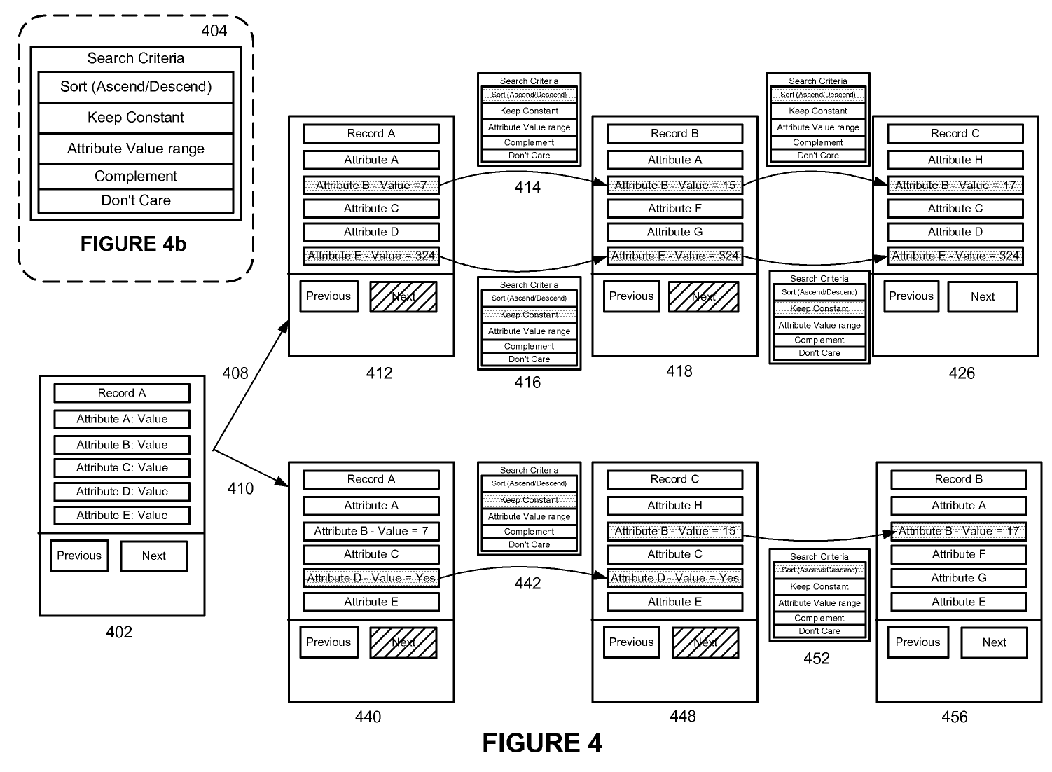

FIG. 4 illustrates graphically how the process described above can be used with a visual text record display interface to allow a user to graphically change the search criteria, and to successively perform searches to locate desired data items. FIG. 4b illustrates by way of example some of the constraints 404 that can be applied to one or more of the attributes of a data item in performing a search. For example, “sort by” causes the search to be sorted by that attribute value (either in ascending value, or descending value); “keep constant” causes the search to return only items that include that attribute value (such as attribute=Yes, or attribute=No); “complement” causes the search to include the opposite or complement of that attribute value; “attribute value range” allows a desired value of attributes to be entered by the user (with in some instances the assistance of the computer which can indicate to the user the full range of available attribute values); and “don't care” is evident, i.e. that attribute is ignored by the system in the ordering or search process. Other constraints, in addition to those shown in FIG. 4b can be used in accordance with other embodiments, In accordance with an embodiment, each of the attributes in a data record can be tagged with one or more constraints, for example through the use of a drop-down menu or other device associated with each attribute, As shown in FIG. 4, the system initially displays a first data item or a first record 402, in this instance record A, together with the associated data attributes for that data item. As further shown in FIG. 4, the user may select one or more of these attributes for use in the dynamic searching. In one example 408, attribute B has been selected and in this instance marked as “sort by” increasing value 414; while attribute E has been selected, and in this instance marked as “keep constant” 416 or another constraint that informs the system that successive data items must include this attribute. By selecting these attributes the user can inform the system that those attributes should be used in the dynamic ordering or search step. When the user clicks on the “next” button to perform the dynamic search the system finds the next data item 418 that includes the attributes previously identified by the user, in this instance record B. In effect, the user has selected the criteria which are then used as constraints during the ordering or search step. Furthermore, it can be seen the search criteria are selected graphically, without the user having to enter the search criteria in a text format. The user can successively click on the “next” button to find the next data items 426 in the database that also match the previously selected constraints, in this instance record C onwards. In this manner the user can quickly constrain their search so that the data items displayed on their screen are only those that match the criteria selected by the user. As further shown in FIG. 4, if the user had initially specified a different constraint at the outset 410, say by selecting attribute D in record A 440, and specifying that this attribute be kept as a constant “yes” 442, then when the user clicks on the “next” button to perform the dynamic ordering or search the system would find the next data item 448 of similar data type, that also included attribute D, in this instance record C. As such, by specifying different constraints, the user is able to effectively skip over unwanted data records, and traverse only through those records of interest, i.e. that match the users' specified constraints. The constraints can then be modified again, such as specifying attribute B be ordered by increasing value 452, to traverse in a different direction within the data items and locate additional records 456.

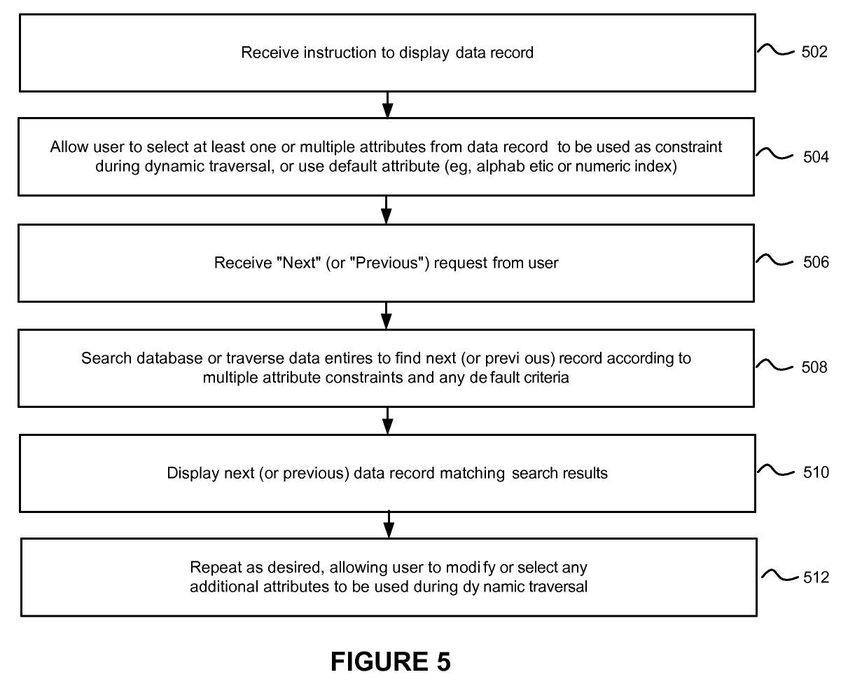

FIG. 5 illustrates a process in accordance with an embodiment of the invention that illustrates how the system receives information from the user and then uses this information to perform a concurrent search in the graphical environment, allowing the user to dynamically modify their search criteria to further specify certain attributes. As shown in FIG. 5, in step 502 the system receives an instruction to display a particular data record, and displays the first data record for the user, together with the data from the database. In step 504, the system allows the user to select at least one or multiple attributes from the data record, which will be used as constraints during the dynamic traversal process. Alternatively a default attribute, for example an alphabetic or numeric index can be used. In step 506, the system receives a “next” (or “previous”) request from the user, typically by use of a “next” button or some other interface by which the user can activate the dynamic searching process. In step 508, the system searches the database, i.e., traverses to find the next (or previous) record in the database that matches the multiple attribute constraints and any default criteria set either by the user or by the system itself. In step 510 the next i.e., the subsequent data record is displayed, which matches the search results and search constraints. In step 512, the system allows the user to repeat the search as desired, in each step allowing the user to modify or select any additional attributes as constraints during the dynamic traversal process.

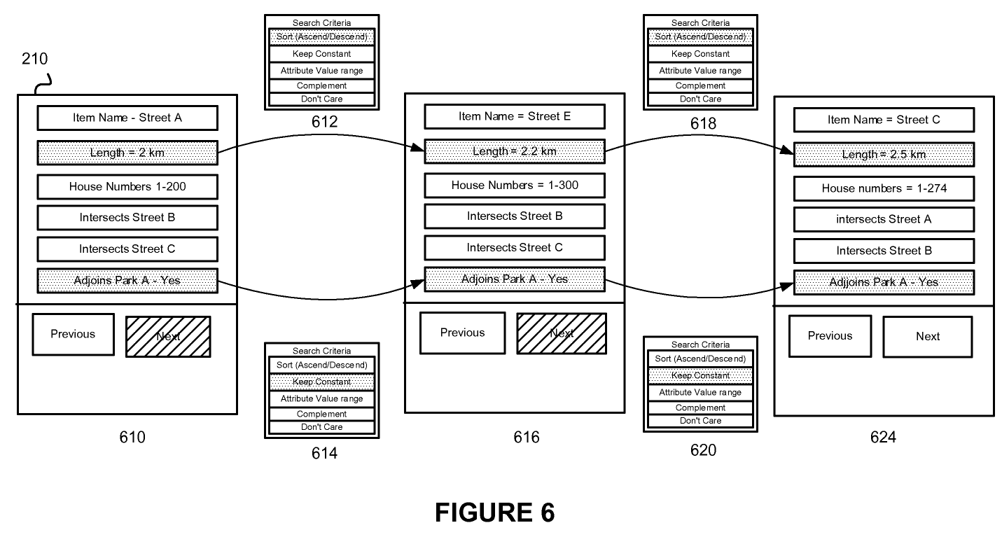

FIG. 6 graphically illustrates how the embodiment of the invention described above can be used to quickly locate street items that match the users criteria, selected from the map example shown in FIG. 1. As shown in FIG. 6, the process begins by allowing the user to select a particular map item 610, for example street A. If constraints are not used then selecting the “next” button would merely cause the system to move from streets A through B, C, D, and E according to their alphabetic name or unique item identifier. However, in accordance with an embodiment, using the above search methodology the user is able to select additional criteria for use in traversing or ordering the data items, or searching within the database. In this instance, the user can constrain the attributes that the street length be ordered by increasing street length 612, and that a map item also adjoins park A 614. These attributes will then be used as a constraint during the dynamic traversal process. As shown in FIG. 6, when the user clicks the “next” button, the next map item 616 that matches the constraint is selected (i.e., that it has the next higher street length and that it adjoins park A, and is also of a similar map type, i.e., a street), in this instance street E. When the same criteria are used 618, 620 and the user selects “next”, then the next item 624 matching the constraints and of the similar type is displayed, in this instance street C. As can be seen in FIG. 6, using this approach the number of steps taken to find all map items that adjoin park A can be reduced to two clicks of the “next” field instead of four clicks as would be needed in the absence of constraints. Although this is a relatively simple example, the ability of the invention to reduce the number of steps used by the user to quickly locate, and update desired data items, while stepping through them, can be seen. It will be evident that the approach described herein becomes more advantageous when the number of data items greatly increases and the amount of available constraints becomes larger, such that the user is given a powerful means by which they can constrain their successive search queries.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for multiple attribute concurrent searching, comprising:
a computer for receiving an instruction from a user to display a data item of a database;
an interface for
displaying a first data record for the data item;
allowing the user to select at least one or multiple attributes from the data record to act as a constraint;
receiving a request from the user to find a next or subsequent data record;
searching the database to find the next data item in the database that matches the multiple attribute constraints and any default criteria set either by the user or by the system itself;
displaying the subsequent data record which matches the search results and search constraints; and
allowing the user to repeat the search as desired to traverse through multiple data records corresponding to data items in the database, including allowing the user to modify or select any additional attributes during the search process.

2. The system of claim 1, wherein the database is a digital map.

3. The system of claim 2, wherein each data item is a map item in the digital map.

4. The system of claim 1, wherein the constraint includes any one or more of “sort by”, “keep constant”, “complement”, “attribute value range”, and “don't care”.

5. The system of claim 1, wherein, rather than accessing the database at each request for the next or subsequent data record, the system sorts or orders a cache or set of data items previously retrieved from the database.

6. A method for multiple attribute concurrent searching, comprising the steps of:
receiving an instruction from a user to display a data item of a database;
displaying a first data record for the data item;
allowing the user to select at least one or multiple attributes from the data record to act as a constraint;
receiving a request from the user to find a next or subsequent data record;
searching the database to find the next data item in the database that matches the multiple attribute constraints and any default criteria set either by the user or by the system itself;
displaying the subsequent data record which matches the search results and search constraints; and
allowing the user to repeat the search as desired to traverse through multiple data records corresponding to data items in the database, including allowing the user to modify or select any additional attributes during the search process.

7. The method of claim 1, wherein the database is a digital map.

8. The method of claim 2, wherein each data item is a map item in the digital map.

9. The method of claim 1, wherein the constraint includes any one or more of “sort by”, “keep constant”, “complement”, “attribute value range”, and “don't care”.

10. The method of claim 1, wherein, rather than accessing the database at each request for the next or subsequent data record, the system sorts or orders a cache or set of data items previously retrieved from the database.
